(19) United States
(12) Patent Application Publication
(10) Pub. No.: US 2006/0041509 A1
(43) Pub. Date: Feb. 23, 2006

(54) Broadcasting of software packages

(76) Inventor: Eric Jos Bert Koerber, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/530,306

(22) PCT Filed: Sep. 18, 2003
(86) PCT No.: PCT/IB03/04157

§ 371 Date: Apr. 4, 2005

(30) Foreign Application Priority Data
Oct. 7, 2002 (EP) 02079169.5

(51) Int. Cl. G06Q 99/00

(52) U.S. Cl. 705/51

(57) ABSTRACT

A broadcast receiver includes a communication interface 210 for receiving data from a broadcast communication system. A storage 260 stores software components executable by processor 250 and stores configuration information identifying the executable software components. The receiver receives through the communication interface a software package description indicating software components that must have been installed in the broadcast receiver before accepting a software package associated with the software package description; and the associated software package including at least one executable software component. The receiver determines whether the software package can be installed by comparing the software package description with the configuration information stored in the storage of the receiver; and upon a positive determination: stores the at least one software component of the software package in the storage and updates the receiver's configuration information accordingly.

### FIELD OF THE INVENTION

The invention relates to a method of broadcasting software packages from a software server to broadcast receivers, in particular digital broadcast receivers and set top boxes. The invention also relates to broadcast receivers.

### BACKGROUND OF THE INVENTION

The functionality of broadcast receivers, such as digital TVs and set top boxes (STBs) increases continuously. As a consequence, the amount of executable software in the receivers also increases. This implies that there is an increased demand for fixes to software bugs and for addition of new software features to the installed software.

Until now, occasionally a server in the system broadcasted an entire new software image to the broadcast receivers. The image includes all software components, also the already present and unmodified components. With image is meant the set of software components (modules) that together form the complete replaceable executable software of the receiver. The receivers that were switched on (full power or in stand-by) could receive the new image. The new image is installed automatically or after approval of a user. In itself broadcasting is an effective way of limiting the demand on the resources of the broadcasting system. However, since receivers can be switched-off, a new image needs to be broadcast regularly. Since the image may increase in size, a too frequent broadcasting may consume too much bandwidth of the broadcasting system. The approach of broadcasting is complicated further by the fact that broadcast receivers may have hardware differences, resulting in a need for different images to be broadcast. The different images need then to be transmitted to selected receivers, complicating matters further.

### SUMMARY OF THE INVENTION

It is an object of the invention to improve updating of executable software in broadcast receivers.

To meet the object of the invention, a method of providing executable software from a software server to a plurality of broadcast receivers via a broadcast communication system, includes:

maintaining in each broadcast receiver a configuration information identifying executable software components installed in the broadcast receiver;

broadcasting from the software server to the broadcast receivers a software package description indicating software components that must have been installed in a broadcast receiver before accepting a software package associated with the software package description; and the associated software package including at least one executable software component;

in each broadcast receiver determining whether the software package can be installed by comparing the software package description with the receiver's configuration information; and upon a positive determination: installing the software package and updating the receiver's configuration information accordingly.

By in each broadcast receiver maintaining information on installed software components and broadcasting a description of which component(s) must be present before the software package may be installed, it becomes possible to broadcast the same package to all receivers, even if the package is not suitable for the receiver due the hardware or installed software of the receiver. In this way, broadcasting (i.e. performing one transmission receivable by all receivers) can still be applied even in situations with diverse hardware and software. There is no need for direct addressing of individual receivers or of repeated multicasting for different groups of receivers with different hardware/software profiles. The invention enables creating one software package with components suitable for several groups of receivers, where each group has a different hardware/software profile. The size of the total package may be substantially larger than the image size of an individual receiver. The receiver simply selects the components that it needs and meet its configuration. It is also possible to create software packages for individual groups of receivers.

As described in the dependent claim 2, the configuration information includes for each installed software component a respective unique component identification, and the software package description includes the unique component identification of each software component that must have been installed in a broadcast receiver before accepting the software package; and wherein the step of comparing the package description with the receiver's configuration information includes checking whether all component identification(s) in the software package description are part of the configuration information. Checking component identifications is an easy way of verifying whether the new package is suitable for the receiver.

As described in the dependent claim 3, the software package includes at least one update of a software component; the software package description including the unique component identification of the software component. In this way, individual software components (or groups of components) can be replaced by newer versions, e.g. to overcome a software bug in a component. It is no longer required to broadcast an entire image if only part of the software components is renewed.

As described in the dependent claim 4, the software package includes a software component that requires a differing further software component to have been installed in the broadcast receiver; the software package description including the unique component identification of the further software component. In this way one or more new components can be installed that can only be executed if certain other component(s) are already present. This makes it possible to deal in a reliable way with different software configurations.

As described in the dependent claim 5, wherein the configuration information includes for each installed software component a respective component version identification associated with the unique component identification; and wherein the software package description includes for each software component that must have been installed in a broadcast receiver before accepting the software package an associated component version identification; and wherein the step of comparing the package description with the receiver's configuration information includes checking for whether component identification(s) and associated component version identification(s) in the package description are also part of the configuration information. By using version identifications, like version numbers, software components can be identified more accurately by their component ID and version ID.

As described in the dependent claim 6, the component version identification in the software package description includes at least one of the following:
an identification of one version;
an identification of a minimum or maximum version, where versions are sequentially arranged;
an indication of a sequential range of versions.

This makes it even easier to deal with differing configurations, in particular it makes it possible to specify for a software component one or more acceptable version numbers in one package description.

As described in the dependent claim 7, the software package description includes a plurality of acceptable software configurations where each software configuration indicates software components that must have been installed in a broadcast receiver before accepting the software package; and wherein the step of determining whether at least one software component of the software package can be installed includes verifying if at least one of the acceptable software configurations corresponds to the receiver's configuration information. By in the package description sending out several acceptable configurations, one broadcasted software package can be accepted by receivers with more than one configuration. This reduces the load on the broadcasting system. Another significant advantage is that the receiver is spending less time in downloading the software image and storing it in a permanent memory, such as a flash memory. This reduces the risk of damaging the image as during the writing the receiver could be switched off by the user, thereby leaving an incomplete, corrupted image in the receiver.

As described in the dependent claim 8, a complete software image of a broadcast receiver can be broadcast from the software server to the broadcast receivers. In this way, receivers that have been switched-off for a very long time and no longer meet the minimum requirements can still be updated. Such an update using a full image can occur at a very low frequency.

As described in the dependent claim 9, the broadcast receiver can, in response to determining that at least one required software component is not installed, download the not installed software component(s) from the software server; install the downloaded software component(s) and update the receiver's configuration information accordingly. In this way an ‘individual’ update of a single receiver can ensure that this receiver is capable of receiving future broadcast packages. This is particularly useful if the receiver was too far out-of-date to be able to accept certain broadcasted packages. Preferably, the receiver notices that it can not accept a package and takes the initiative to download an update. Alternatively, the server may occasionally check whether this is the case and take the initiative for the download.

To meet the object of the invention, a broadcast receiver includes:

a communication interface for receiving data from a broadcast communication system;

a storage for storing software components executable by a processor and for storing configuration information identifying the executable software components;

a processor for executing the stored software components; at least one of the software component being operative to cause the processor to:
receive through the communication interface:
   a software package description indicating software components that must have been installed in the broadcast receiver before accepting a software package associated with the software package description; and
   the associated software package including at least one executable software component;
determine whether the software package can be installed by comparing the software package description with the configuration information stored in the storage of the receiver; and
upon a positive determination: store the at least one software component of the software package in the storage and update the receiver's configuration information accordingly.

These and other aspects of the invention are apparent from and will be elucidated with reference to the embodiments described hereinafter.

### BRIEF DESCRIPTION OF THE DRAWINGS

In the drawings:

FIG. 1 shows a broadcast system in which the invention can be employed;

FIG. 2 shows a broadcast receiver according to the invention;

FIG. 3 illustrates a package description specifying multiple configurations. And

FIG. 4 illustrates a flow-chart of the method according to the invention.

### DETAILED DESCRIPTION OF THE PREFERRED EMBODIMENT

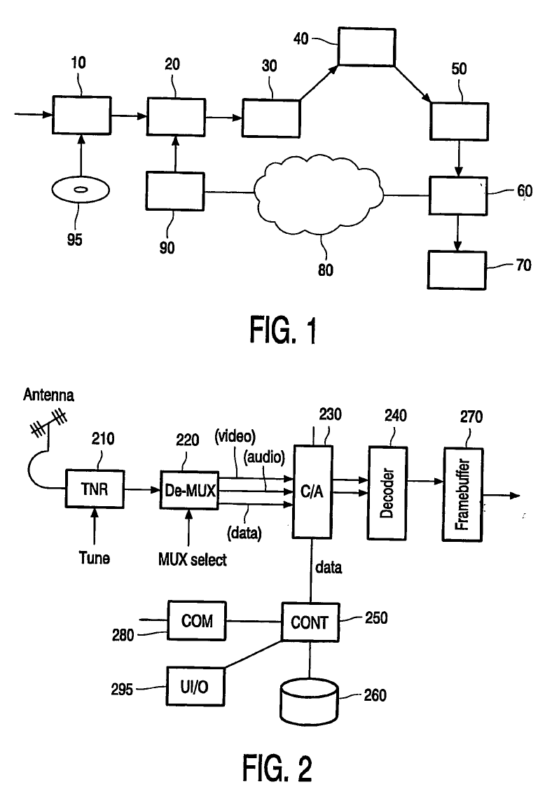

FIG. 1 gives an overview of a digital television system in which the broadcast receiver and broadcasting of software packages according to the invention can be used. In general, the software distribution/updating according to the invention can be applied in any broadcast system, also including updating of hand-held devices, like mobile phones and PDAs, with broadcast reception capabilities. As an example, a system is described wherein the audio/video (A/V) signals are distributed digitally using MPEG-2 compression to compress the A/V signals. The system includes an MPEG-2 compressor 10, usually located in a broadcast centre. The compressor receives a digital signal stream (typically a stream of digitized analog or digital video signals). The original signals are supplied by a service provider. The compressor is connected to a scrambler and multiplexer 20. The scrambler, optionally, scrambles the digital signals of a data stream by encrypting them under control of a content key, as will be described in more detail below. The multiplexer 20 receives in addition to one or more scrambled or non-scrambled data stream also further digital signals. In particular, the multiplexer receives digital data representing software executable by the broadcast receivers. The software is supplied by a software server 90 in the form of software packages, as will be described in more detail below. The multiplexer 20 assembles all the signals and streams into a transport stream and supplies the compressed and multiplexed signals to a transmitter 30 of the broadcast centre. The scrambling and multiplexing functions may be performed in separate units, and if desired at different locations. The multiplexed transport stream may be supplied from the scrambler/multiplexer 20 to the transmitter 30 using any suitable form of linkage, including telecommunication links. The transmitter 30 transmits electromagnetic signals via an uplink towards a satellite transponder 40, where they are electronically processed and broadcast via a downlink to an earth-based satellite receiver 50, conventionally in the form of a dish of the end user. In the figure, the satellite receiver 50 is connected to an integrated receiver 60. The operation of the receiver 60 is described in more detail below with reference to FIG. 2. The receiver selects the desired signal and presents it in a suitable form to a rendering device, such as a television 70. The signal may also be recorded using a tape, optical disc or hard disk recorder or other suitable recorder. The signal may be supplied to the rendering/recording device in an analog or digital form using well-known distribution systems such as CATV cable, or IEEE 1394. It will be understood that the main distribution of the signals does not need to take place via satellite. Instead other delivery systems (i.e. the physical medium by which one or more multiplexes are transmitted) may be used, such as terrestrial broadcast, cable transmission, combined satellite/cable. The party that distributes the data via the delivery system is sometimes referred as the network provider. It will also be understood that the receiver/decoder 60 may be integrated into the rendering or recording device.

A typical system operates as a multi-channel system, implying that the multiplexer 20 can handle A/V information received from a number of (parallel) sources and interacts with the transmitter 30 to broadcast the information along a corresponding number of channels or multiplexed into separate transport streams. In addition to A/V signals, messages or applications or any other sort of digital data may be introduced in some or all of these services/channels interlaced with the transmitted digital audio and video information. In particular, the digital data may represent a software package. As such, a transport stream includes one or more services, each with one or more service components. A service component is a mono-media element. Examples of service components are a video elementary stream, an audio elementary stream, a program package according to the invention, or other data type. A transport stream is formed by time-multiplexing one or more elementary streams and/or data. Normally, broadcast data is received by all active receivers in the broadcast system. However, it will be understood that, where applicable, with broadcasting of software packages is also meant ‘multicasting’ where only a subset of a plurality of receivers receives the software package that is transmitted in one, transmission to the group of receivers (unlike using separate transmissions each addressed to only one receiver).

The distribution of software according to the invention can in principle take place only using a one-directional broadcast system, like the one described for FIG. 1. Preferably, bidirectional communication is enabled in the system to facilitate additional features, in particular receiver specific operations. The communication path back from a broadcast receiver to the software server may be established in any suitable way. Shown is the use of a wide area network 80, preferably the open Internet, connecting the broadcast receivers to the software server 90. To enable broadcasting of software packages stored on the software server 90, preferably, the software server 90 also has a connection to the multiplexer 20. This may be a direct link but may also be via the Internet. It will be understood that the communication functionality of Internet or similar communication system may be provided in any suitable form. For example, the receiver may communicate via a cable network or satellite connection, directly using Internet protocols. Alternatively, the receiver may have a telephone-based dial-in connection to an access provider that provides access to the Internet. The receiver may, but need not use Internet protocols. If the server 90 does use Internet protocols, protocol conversion may take place, for example using a gateway. It will also be appreciated that the software may also be supplied by other servers to the software server 90 for distribution via the communication system.

FIG. 2 shows more details of a typical broadcast receiver. The broadcast receiver, preferably, complies with a defined platform like the European MHP (Multi-media Home Platform) or the US DASE platform. The broadcast receiver includes a tuner 210. The tuner 210 extracts a separate tunable Radio Frequency (RF) band usually resulting in an MPEG2 transport stream. Variable data signals are separated from the constant carrier signal by the de-multiplexer 220 (De-MUX). The results often are audio, video and data outputs. In the exemplary system, the software packages according to the invention are output as data. The video and audio streams may be fed through a Conditional Access subsystem 230, which determines access grants and may decrypt data. The audio and video streams are fed to a decoder 240, which converts them into signals appropriate for the video and audio rendering or storage devices. This may involve MPEG2 decoding. Typically, the output of the decoder 240 is first stored in a frame buffer 270 for subsequent supply to the rendering/storage device. Preferably, the receiver also includes the communication interface 280 for bi-directional communication to the software server. Any suitable communications hardware/software may be used for this, including conventional modems for standard telecommunication lines or broadband modems. The bi-directional communication channel facilitates more advanced receiver-specific downloading of software components, as well as interactive applications, such as interactive video, e-commerce and so on, and obtaining additional information/functionality from, for example, a web site. Preferably, Internet protocols are used, for example those defined in the MHP “Internet Access Profile”. A user interface 295 of the receiver enables the receiver to interact with the user. The user interface 295 may include any suitable user input means, such as an Infrared receiver for receiving signals from an IR remote control, a keyboard, or a microphone for voice control. For output, also any suitable form may be used, such as using a small LCD display or using the display of a television, or even audible feedback.

It will be appreciated that the various functions, such as the tuner function 210, the de-multiplexer function 220, the optional descrambler/decryptor function 230, and the decoder function 240 may be performed using dedicated hardware. Some functions or part of the functions may also be performed by a programmable processing function, for instance using a digital signal processor (DSP) loaded with a suitable program. The various functions within the receiver are operated under control of the controller 250, which typically includes an embedded microprocessor or microcontroller. To keep the figure simple, the control relationship between the controller and the other functions are not shown. Only the role that the controller can have in processing of the software packages is shown.

The broadcast receiver, like for example shown in FIG. 2, includes several software component. Typically, the software is organized hierarchically, for example in layers of hardware drivers, middleware, application programming interfaces (APIs), and application programs. The receiver of FIG. 2 can have many hardware components that are each controlled by their own software drivers. Examples of such hardware are: tuner, decoder, descrambler, communication hardware (e.g. modem, local area network), display, audio amplifier/converter, infrared receiver, etc. The middleware may include interaction channel protocols prescribed by the (MHP) standard, such as TCP/IP, http and DSM-CC Internet protocols. The APIs may be the ones defined by MHP. Examples of application programs include resident applications, such as a zapper (for changing services), an ESG or EPG, a setup menu, and downloadable applications, like a weather application, or a golf application (additional info of the sport transmitted during the game like wind speed, distances, etc).

Typically, the various software components are executed by the controller 250. Since increasingly also the basic signal processing functionality is implemented in software, also a signal processor in the system may execute several software components. In the figure only one processor is shown. Also in the remainder of the description, reference will normally be to only one processor. It will be appreciated that this also covers the situation where the software components are actually executed by multiple processors in the receiver. The executable software components are loaded from a storage 260. This may be a non-volatile memory, such as a flash memory, or even a hard-disk or other permanent background storage. During execution the program components are usually loaded in a volatile memory, like a DRAM (not shown in the figure).

Preferably, the individual executable software components are uniquely identifiable. This may be done by giving each component a unique software identification in the form of a number. The number may be digitally represented in the form of a sequence of bytes. Particularly if the identification is also presented to a user, it is preferred to use a (sequence of) (alpha-)numeric characters as the identification. Using only a component identification may be sufficient where the software package is an extension of existing software in the receiver and for the package it is only indicated which modules need to be present. Particularly for updating of already present software it is preferred that more information is present on the installed software components. This additional information may be a version identification. The version identification may take any suitable form. For the remainder it is assumed that the version identification follows a scheme that enables the receiver to identify that a component is more recent that an already installed component. The version identification may, for example be formed by two or three number, where a first number indicated the major release, the second/third number indicated minor improvements. Alternatively or additionally, the version number may be a date (e.g. production date of the software components, or distribution date).

According to the invention, each broadcast receiver maintains configuration information identifying executable software components installed in the broadcast receiver. This may be stored in a suitable memory/storage such as a same non-volatile memory 260 as used for storing the software component. Via the broadcasting system two parts are broadcast. A first part is a software package description. A second part is the software package itself. The two parts may be broadcast sequentially in one operation. It is also possible to first broadcast the description and at a later moment transmit the package in a separate broadcast. In this latter approach, a broadcast receiver has more time to determine whether or not to receive the package. The receiver may need to do preparatory steps, like cleaning up memory/storage to be able to store the package. It will be appreciated that the receiver temporarily may need to clear extra storage space in order to be able to store the already installed software component as well as the newly broadcast components. If so desired, the broadcast components may only be installed after having verified that the components are not corrupt. In a preferred embodiment, the package description is put in a broadcast carousel together with the software package. The broadcaster ‘continuously’ broadcasts the carousel for a certain period, such as a few days. Normally loading of a desired component will take a few minutes, giving the receiver ample time to perform the loading during this period. Even if a loading error occurs (e.g. the user interrupts the receipt) normally there will be sufficient time to correct this. Preferably, the package description is in the carousel every few seconds, i.e. with a substantially higher frequency than the software package. The description may also be broadcast a few weeks preceding the broadcast of the actual software package. The receiver is then informed of the moment of the broadcast of new components. Preferably, as part of the broadcast of the software package also the description is still broadcast, enabling receivers to immediately process the package.

In itself it is known how apparatuses operated under control of embedded software can securely replace or extend executable software by/with newly received components and ‘roll-back’ if there is an error. This will not be described further. As a preparatory step the receiver may also ask a user for permission to install the software package. Since normally the package description is relatively small (compared to package itself), the description may be broadcast several times enabling also receivers that were de-active at the first transmission to receive the package description. Preferably, a link exists between the package description and the package itself Such a link may be in the form of a package identifier (e.g. sequential number). This simplifies for the broadcast receiver, after it has decided to accept a package based on a package description, identifying the actual package.

The software package description indicates software components that must have been installed in the broadcast receiver before accepting the corresponding software package that is associated with the software package description. If the package is actually broadcast at a much later moment in time, preferably the package description also includes an identification of the actual broadcast time. This enables the receiver to be active in order to receive the package at the moment of the broadcast. The software package includes at least one executable software component. In response to receiving the package description, the broadcast receiver determines whether the software package can be installed. It does this by comparing the software package description with the receiver's configuration information. If the outcome is positive, the receiver will make sure it receives the package (or at least the components of the package in which it is interested) if it has not yet received the package and install the software package (or at least those components in which it is interested). The receiver updates its configuration information accordingly. It will be appreciated that if the package description and the package are broadcast in one operation, the receiver may actually have to receive all components of the package in which it is interested and temporarily store it before it has finally decided that it will install the package (or at least part of it). If the outcome of the verification is negative (or only partly positive) the not-installed component(s) may simply be discarded.

As described above, the configuration information may include for each installed software component a respective unique component identification, and the software package description may include the unique component identification of each software component that must have been installed in a broadcast receiver before accepting the software package. This approach is very suitable for extending the functionality of the receiver with new software components, that can only work if certain other component(s) have already been installed. Those other components are then indicated in the package description. The receiver compares the package description with the receiver's configuration information by simply checking whether all component identification(s) in the software package description are part of the configuration information. If so, the package can be accepted and installed; if not, the package need not to be received or, if already received, can be discarded.

For updating of existing software components, the software package includes at least one update of a software component that may already be installed in one or more broadcast receivers. The software package description includes the unique component identification of the software component Using only the component identification in the package description will have as an effect that a broadcast receiver that already has the component will normally install the newly broadcast component, even if this is the same as the one that is already installed. Preferably, the package description includes a component version identification for each software component that must have been installed in a broadcast receiver before accepting the software package. The configuration information in the broadcast receiver includes for each installed software components a respective component version identification associated with the unique component identification. The broadcast receiver compares the package description with the receiver's configuration information. This includes checking that the component identification(s) in the software update description are part of the configuration information. If so, the versions numbers for the corresponding component identifications must also match. In this way, the broadcast receiver will not update a software component if it already has the updated software installed. Moreover, this also enables broadcasting software patches (corrections of only part but not all of a software component) that only needs to be applied for certain version(s) of the component, but not for all versions.

The system may support several ways of indicating a version of the software component. The following table shows four options. The first column shows a 2-bit indicator that is part of the package description and indicates which option is used. The second column gives a textual explanation (needs not be included in the package description). The third column carries a version number as relevant for the selected option; in the table it is indicated if this information is present in the package description. The fourth (optional column) carries second version number; in the table it is indicated if this information is present in the package description. The actual package description may include columns 1, 3 and 4 of the table, where columns 3 and 4 are filled with actual version identification(s).

| Option | | 1^{st} version | 2^{nd} version |
|---|---|---|---|
| number | Description | number | number |
| 00 | Absolute version | Yes | No |
| 01 | Minimum version | Yes | No |
| 10 | Maximum version | Yes | No |
| 11 | Range of versions | Yes | Yes |

The options are:
Absolute version number: the package is only relevant of the identified component has the 1^{st} version number indicated in package description.
Minimum version number: assuming that updates are number sequentially higher (using any suitable scheme), this option allows specifying that the package may only be installed in combination with ‘recent’ components with versions numbers starting at the 1^{st} version number of the package description.
Maximum version number: similar to the minimum option, this option allows specifying that the package may only be installed in combination with ‘older’ components with versions numbers up to and including the 1^{st} version number in the package description. This option is particularly suitable for updating old components with improvements that are already included in the newer components.
Range of versions: this option enables replacement of a consecutive range of versions, allowing to exclude very ‘old’ versions, which for example are no longer compatible with the other software component in the package, and very ‘recent’ components that are already up to date. A lower version may be indicated using the 1^{st} version number in the package description, whereas the upper version may be indicated using the 2^{nd} version number.

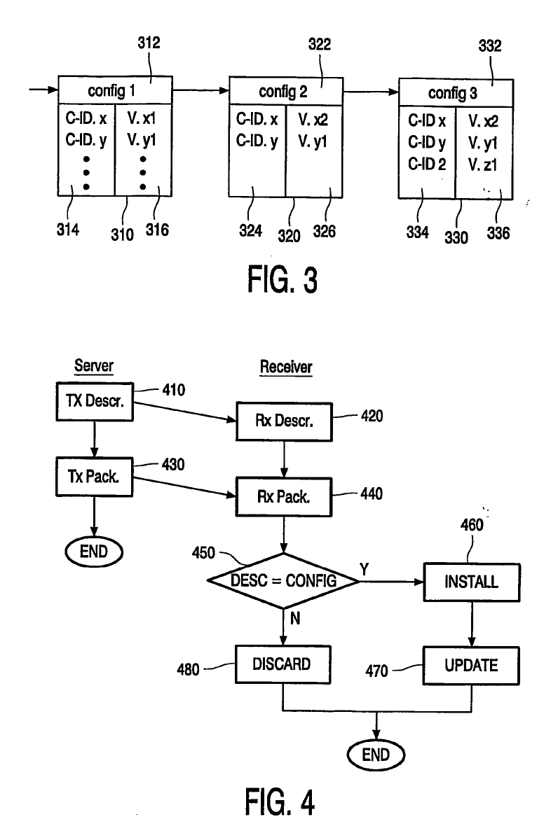

It will be appreciated that also other suitable schemes may be used to specify allowable component identifications and/or version identifications. For example, different possibilities may be specified using Boolean operators, such as the package may be installed IF (component X has version X1 AND component Y has version Y1) OR (component X has version X2 AND component Y has version Y2 AND component Z has version Z1). In this way in fact, two acceptable configurations are indicated. This may be represented in any suitable way. One way of doing this is illustrated in FIG. 3. Here the package description includes three possible configurations 310, 320 and 330. The figure shows that the package description is a linked list of configurations. It will be appreciated that other ways may be used as well. In the example, each configuration includes an optional configuration number 312, 314, and 316, respectively, to identify the configurations. Each configuration includes a further list of components that must be present. As example, in the figure for each component the component identification is given in columns 314, 324 and 334, respectively, and the version identification is given in the columns 316, 326 and 336, respectively. The broadcast receiver can simply sequentially check the configuration until it has found one acceptable software configuration that corresponds to the receiver's configuration information. If it has checked all configurations in the package description and no matching one has been found, the corresponding software package can not be installed.

Particularly to overcome the situation wherein some broadcast receivers are too out-of-date to be updated in the normal scheme, occasionally (e.g. once every half year) a complete software image is broadcast from the software server to the broadcast receivers with the corresponding hardware profile via the broadcast communication system. Preferably, the full image is also accompanied by a package description according to the invention of all software components, so that an up-to-date receiver can verify that it does not need to install the image.

In a preferred embodiment, individual broadcast receivers may come to the conclusion that they are not allowed to install a broadcast package, e.g. because of the fact that certain components are not installed in the receiver or that some components are too out-of-date. The broadcast receiver may take the initiative to correct this, by actively contacting the software server (e.g. via the Internet), downloading the not installed (not installed at all, or out-of-date) software component(s) from the server; installing the downloaded software component(s) and updating the receiver's configuration information accordingly. The downloading may also take place via the Internet, but may also be performed via a directed (i.e. addressed) transmission through the broadcast system. Alternatively, the software server may occasionally scan the broadcast receivers in the system and verify if they need an individual update or that they can stay up-to-date via the broadcast software packages. If a receiver needs an individual update, this can be done in any suitable way, like Internet via a dial-in or broadband connection, addressed transmission via the broadcast system, or via CD-ROM.

FIG. 4 summarizes one possible sequence of performing the method according to the invention. In step 410, the package description is broadcast from the software server to the receivers. In step 420, a receiver receives the description. In step 430, the actual software package is broadcast and received in step 440. The receiver then in step 450 compares the package description to its stored configuration information. If this matches, the components of the package are installed (step 460) and the configuration information is updated (step 470) to represent the new modules. If there is no match, in step 480 the received package is discarded. It will be appreciated that many variations in the sequence and details are possible. For example, the check of 450 may be performed ‘immediately’ after receiving the description. If the outcome is negative, the package needs not to be received and discarded.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A method of providing executable software from a software server to a plurality of broadcast receivers via a broadcast communication system; the method including:
maintaining in each broadcast receiver a configuration information identifying executable software components installed in the broadcast receiver;
broadcasting from the software server to the broadcast receivers:
a software package description indicating software components that must have been installed in a broadcast receiver before accepting a software package associated with the software package description; and
the associated software package including at least one executable software component;
in each broadcast receiver:
determining whether the software package can be installed by comparing the software package description with the receiver's configuration information; and
upon a positive determination: installing the software package and updating the receiver's configuration information accordingly.

2. A method as claimed in claim 1, wherein the configuration information includes for each installed software component a respective unique component identification, and the software package description includes the unique component identification of each software component that must have been installed in a broadcast receiver before accepting the software package; and wherein the step of comparing the package description with the receiver's configuration information includes checking whether all component identification(s) in the software package description are part of the configuration information.

3. A method as claimed in claim 2, wherein the software package includes at least one update of a software component; the software package description including the unique component identification of the software component.

4. A method as claimed in claim 2, wherein the software package includes a software component that requires a differing further software component to have been installed in the broadcast receiver; the software package description including the unique component identification of the further software component.

5. A method as claimed in claim 2, wherein the configuration information includes for each installed software component a respective component version identification associated with the unique component identification; and wherein the software package description includes for each software component that must have been installed in a broadcast receiver before accepting the software package an associated component version identification; and wherein the step of comparing the package description with the receiver's configuration information includes checking for whether component identification(s) and associated component version identification(s) in the package description are also part of the configuration information.

6. A method as claimed in claim 5, wherein the component version identification in the software package description includes at least one of the following:
an identification of one version;
an identification of a minimum or maximum version, where versions are sequentially arranged;
an indication of a sequential range of versions.

7. A method as claimed in claim 1, wherein the software package description includes a plurality of acceptable software configurations where each software configuration indicates software components that must have been installed in a broadcast receiver before accepting the software package; and wherein the step of determining whether at least one software component of the software package can be installed includes verifying if at least one of the acceptable software configurations corresponds to the receiver's configuration information.

8. A method as claimed in claim 1, including broadcasting a complete software image of a broadcast receiver from the software server to the broadcast receivers.

9. A method as claimed in claim 1, including the step of the broadcast receiver, in response to determining that at least one required software component is not installed, downloading the not installed software component(s) from the server; installing the downloaded software component(s) and updating the receiver's configuration information accordingly.

10. A broadcast receiver including:
a communication interface for receiving data from a broadcast communication system;
a storage for storing software components executable by a processor and for storing configuration information identifying the executable software components;
a processor for executing the stored software components; at least one of the software component being operative to cause the processor to:
receive through the communication interface:
a software package description indicating software components that must have been installed in the broadcast receiver before accepting a software package associated with the software package description; and
the associated software package including at least one executable software component;
determine whether the software package can be installed by comparing the software package description with the configuration information stored in the storage of the receiver; and
upon a positive determination: store the at least one software component of the software package in the storage and update the receiver's configuration information accordingly.
